(19) United States
(12) Patent Application Publication
(10) Pub. No.: US 2009/0033688 A1
(43) Pub. Date: Feb. 5, 2009

(54) BRIGHTNESS ADJUSTING METHOD AND DEVICE FOR AN LED-BASED DISPLAY PANEL

(75) Inventors: Wan-Jung LIN, Hsinchu (TW); Den-Hua LEE, Hsinchu (TW); Kuan-Rong LEE, Hsinchu (TW); Chin-Tang CHEN, Hsinchu (TW)

Correspondence Address: PATENTTM.US, P. O. BOX 82788, PORTLAND, OR, 97282-0788, US

(73) Assignees: AVID ELECTRONICS CORP., Hsinchu (TW); BEAM GENE CORPORATION, Hsinchu (TW)

(21) Appl. No.: 11/951,979

(22) Filed: Dec. 6, 2007

(30) Foreign Application Priority Data
Jul. 30, 2007 (TW) 096127691

(51) Int. Cl. G09G 5/10

(52) U.S. Cl. 345/691; 345/690

(57) ABSTRACT

A brightness adjusting device for a light-emitting diode (LED) display panel has at least one photo sensor, a control circuit, a timing controller and a driving circuit. The LED display panel is composed of multiple LEDs being divided into groups according to color. The photo sensor sequentially senses brightness of the groups of LEDs and generates brightness values. The control circuit compares the brightness values to standard brightness values. Based on the compared results, the driving circuit adjusts the brightness of corresponding LEDs.

### BACKGROUND OF THE INVENTION

1. Field of the Invention

The present invention relates to a brightness adjusting method and device for a light-emitting diode (LED) based display panel. In particular, the brightness adjusting method and device use photo sensors to sense brightness of the LED-based display panel and adjust the brightness based on the sensed brightness.

2. Description of the Prior Arts

A liquid crystal display (LCD) for personal computers, notebooks or televisions needs a backlight module to generate light. a conventional backlight module usually uses a cold cathode fluorescent lamp (CCFL) as a lighting source. As manufacturing technologies of light-emitting diodes (LED) has gradually improved, white LEDs have come to be used as the lighting source for the backlight modules in LCD's. Each white light LED can be composed of a red LED chip, a green LED chip and a blue LED chip.

However, using LEDs as the lighting source has some problems. One problem is the inevitable aging that will decrease the illumination of the LED. Another problem is the character inconsistency among different LEDs, which results from defects in manufacturing processes and also effects the illumination. If the backlight module cannot provide homogeneous lighting, the display device will have darker and brighter regions.

A color filter sensor (HDJD-J822-SCR00) manufactured by Agilent Technologies can be used to sense the brightness of white LEDs in the backlight module.

With reference to FIG. 4, a conventional backlight module with an LED-based panel is connected to a control circuit (66) and a driving circuit (67). The LED-based panel in the backlight module comprises a reflective layer (61) multiple LEDs (62) and a multi-layer structure. The LEDs (62) are mounted on the reflective layer (61). The multi-layer structure has at least a protection layer (63) and a diffusion layer (64). One or multiple color filter sensors (65) are mounted on the multi-layer structure or in any one of the multiple layers. Each color filter sensor (65) is connected to the control circuit (66).

With further reference to FIG. 5, the LEDs (62) may be white, and each LED (62) has a red LED chip, a green LED chip and a blue LED chip. The color filter sensor (65) can sense the brightnesses respectively of the red, green and blue lights and transmit the sensed results to the control circuit (66). Based on the sensed results, the control circuit (66) causes the driving circuit (67) to output different currents to drive the LEDs (62) and adjust the lighting.

Although the brightness of the LED-based panel can be regulated by the foregoing circuit, the brightness adjustment still has some drawbacks. Since the color filter sensor (65) must sense the brightnesses respectively of red, green and blue, a single color filter sensor (65) consisting of multiple corresponding color filtering elements is necessary. Such a color filter sensor (65) is very expensive, and producing a backlight module with the color filter sensor (65) is also expensive. Accordingly, only a few manufacturers use this color filter sensor so such a brightness adjusting method is hard to be carried out.

To overcome the shortcomings, the present invention provides a brightness adjusting method and device for a light-emitting diode (LED) based display panel to mitigate or obviate the aforementioned problems.

### SUMMARY OF THE INVENTION

The main objective of the present invention is to use cheap and simple photo sensors to sense brightness values of LEDs of different colors of an LED-based display panel and adjust lighting brightness of the LED-based display panel based on the sensed results.

To achieve the objective, a brightness adjusting method in accordance with the present invention comprises the steps of sequentially turning on groups of the LEDs; sensing brightness of the groups of the LEDs with at least one photo sensor and generating brightness values corresponding to different colors; storing the brightness values; comparing the brightness values to default standard brightness values; and adjusting brightness of the LEDs based on the compared results.

A brightness adjusting device in accordance with the present invention comprises at least one photo sensor, a control circuit, a timing controller and a driving circuit. The LED display panel is composed of multiple LEDs being divided into multiple groups based on color. The photo sensor sequentially senses brightness of the groups of LEDs and generates brightness values. The control circuit compares the brightness values to standard brightness values. Based on the compared results, the driving circuit adjusts the brightness of corresponding LEDs.

Other objectives, advantages and novel features of the invention will become more apparent from the following detailed description when taken in conjunction with the accompanying drawings.

### BRIEF DESCRIPTION OF THE DRAWINGS

FIG. 1 is functional block diagram of a LED-based display panel controlled by a brightness adjusting device in accordance with the present invention;

FIG. 2 is a distribution diagram of multiple LEDs of the LED-based display panel in accordance with the present invention with LED color indicated by R for red, G for green and B for blue;

FIG. 3 is a distribution diagram of five photo sensors mounted on the LED-based display panel in accordance with the present invention;

FIG. 4 is a flow chart of a brightness adjusting method for an LED-based display panel in accordance with the present invention;

FIG. 5 is a functional block diagram of a conventional backlight module connected to a control circuit and a driving circuit; and

FIG. 6 is a circuit diagram of part of a circuit of the backlight module in FIG. 5.

### DETAILED DESCRIPTION OF THE PREFERRED EMBODIMENTS

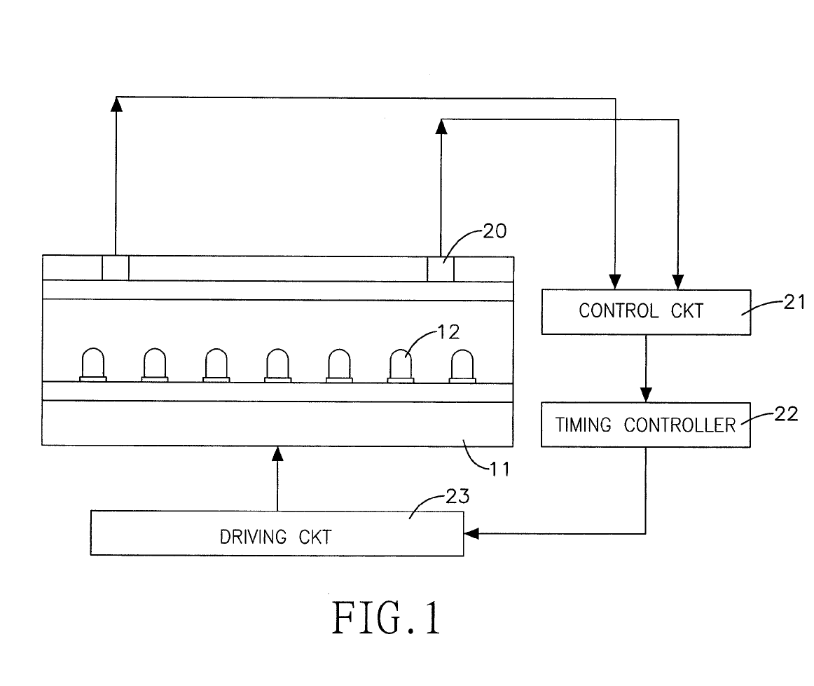

With reference to FIG. 1, an LED-based display panel is operated by a control circuit (21), a timing controller (22) and a driving circuit (23). The control circuit (21) is connected to the timing controller (22). The timing controller (22) is connected to the driving circuit (23).

The LED-based display panel may be a display device such as an advertising board, a video display device or the like and comprises a substrate (11), multiple light emitting diodes (LED's) (12) and at least one photo sensor (20). The LEDs (12) comprise an even distribution of red, green and blue LED's (R, G, B), are mounted on the substrate (11) in a high-density configuration and are driven in three groups according to color, i.e. groups respectively of red LEDs, green LEDs and blue LEDs. Thus, a single color pixel of the LED-based display panel can be formed with a cluster of a red, green and blue LED.

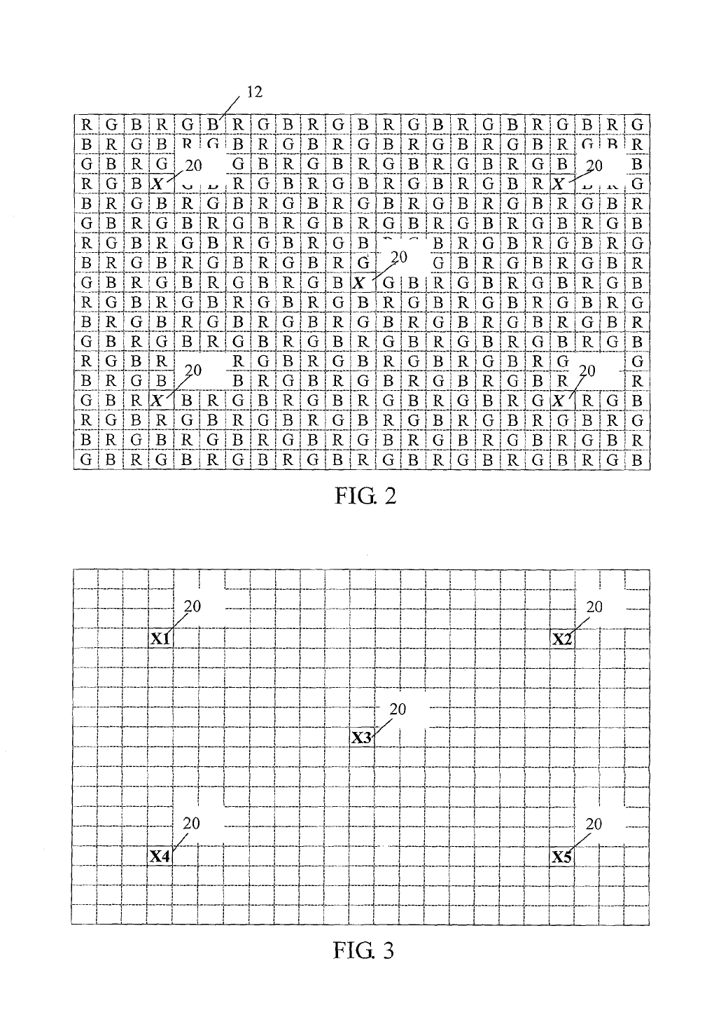

With further reference to FIG. 2, the LEDs (12) are mounted in a matrix. The photo sensors (20) are mounted in such a way that the photo sensors (20) can sense the brightness of the LEDs (12). Where five photo sensors (20) are used, the photo sensors (20) are distributed evenly among the LEDs (12) and are connected to the control circuit (21).

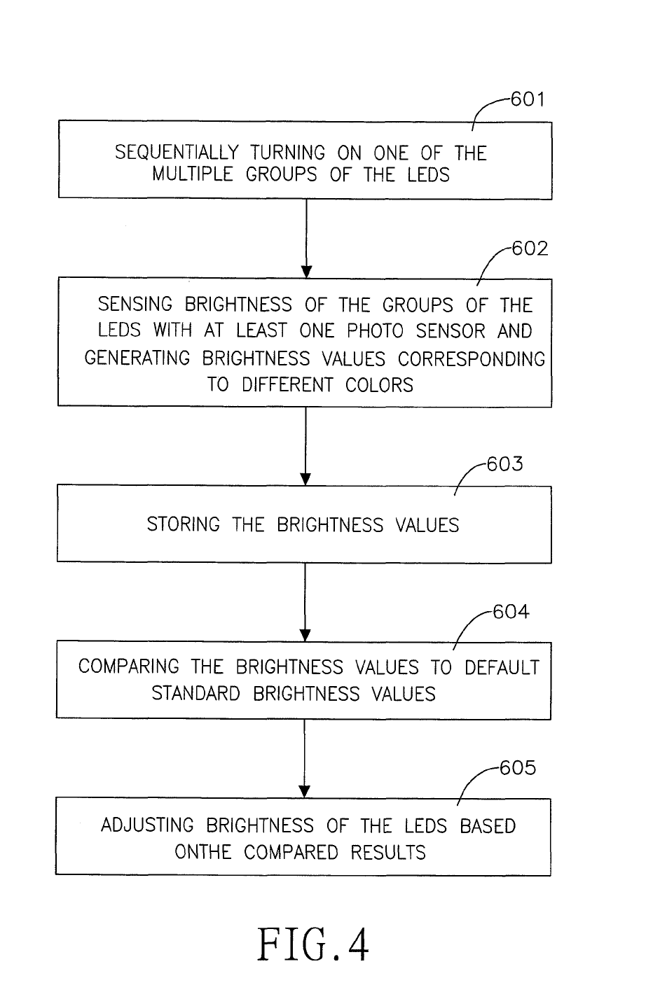

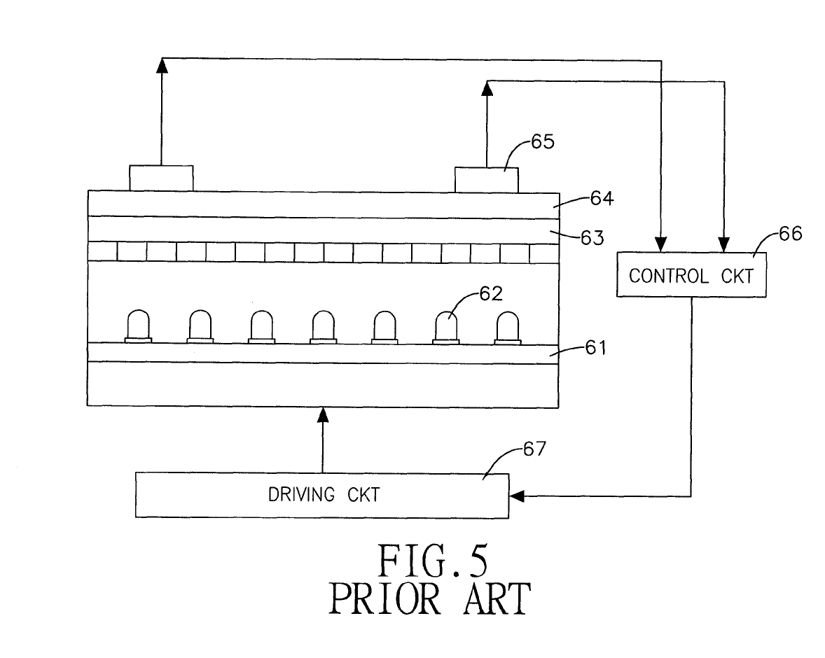

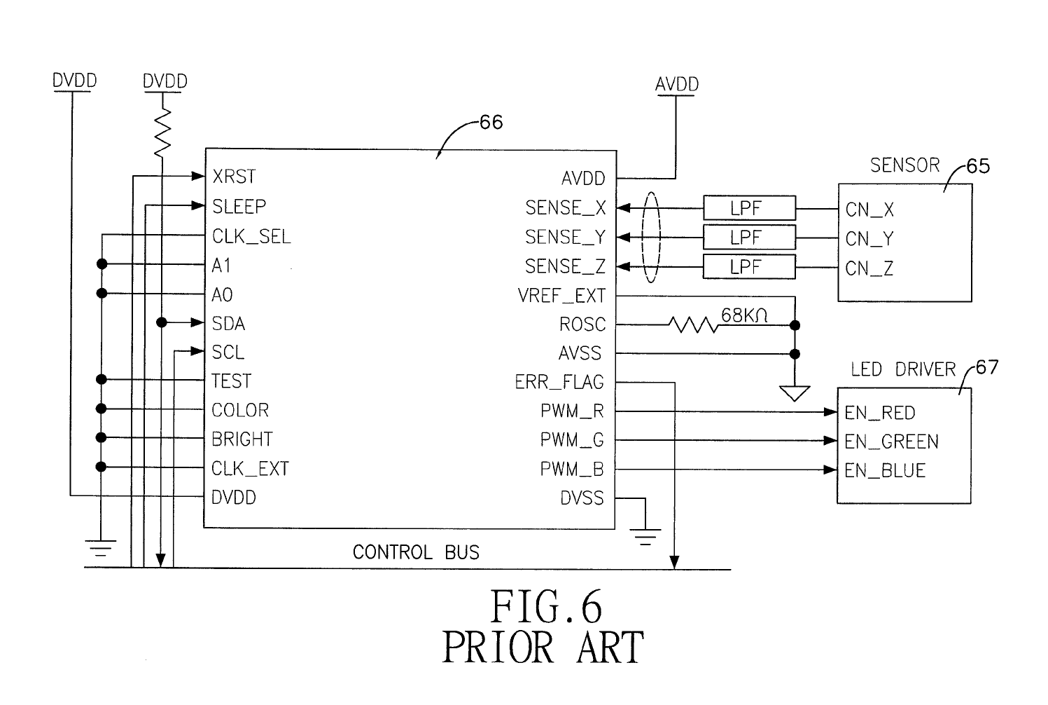

With further reference to FIG. 4, the brightness adjusting method in accordance with the present invention comprises steps of sequentially turning on the groups of the LEDs (601), sensing brightness of each group of LEDs (602), storing sensed brightness values (603), comparing the sensed brightness values to default standard brightness values (604) and adjusting brightness of the LEDs (605).

In the step of sequentially turning on groups of the LEDs (601), the control circuit (21) outputs a signal to the timing controller (22). The timing controller (22) then outputs a timing signal to the driving circuit (23). Based on the timing signal, the driving circuit (22) firstly turns on the first group of the LEDs (12) while other groups are turned-off. After a period, the driving circuit (22) turns off the first group and turns on the next group. By repeatedly doing so, the groups of the red, green, blue LEDs will be sequentially turned on, and only one group is turned on at a time.

With further reference to FIG. 3, in the step of sensing brightness of the groups of the LEDs (602), the photo sensors (20) sequentially sense the brightness of the activated group of the LEDs (12) and generate multiple sets of brightness values corresponding to different colors. For example, when the group of red LEDs is activated, the five photo sensors (20) sense the brightness of the red LEDs and generate a first set of brightness values X_{1R}-X_{5R}. When the group of green LEDs is activated, the five photo sensors (20) sense the brightness of the green LEDs and generate a second set of brightness values X_{1G}-X_{5G}. When the group of blue LEDs is activated, the five photo sensors (20) sense the brightness of the blue LEDs and generate a third set of brightness values X_{1B}-X_{5B}.

In the step of storing the sensed brightness values (603), the sensed brightness values X_{1R}-X_{5R} corresponding to the red LEDs, X_{1G}-X_{5G} corresponding to the green LEDs, and X_{1G}-X_{5G} corresponding to the blue LEDs are transmitted to and stored in the control circuit (21).

In the step of comparing the sensed brightness values to default standard brightness values (604), the control circuit (21) compares the sensed brightness values X_{1R}-X_{5R}, X_{1G}-X_{5G} and X_{1G}-X_{5G} respectively to standard brightness values that have been preset in the control circuit (21) to determine whether the brightness of any LEDs (12) need to be adjusted.

In the step of adjusting brightness of the LEDs (605), the control circuit (21) can based on the compared results increase or decrease the brightness of the LEDs (12). For example, if the sensed brightness value (X_{1R}) generated by the photo sensor (20) is lower than the standard brightness value, the red LEDs (12) in the top left region of the display near the photo sensor (20) have lower brightness, and the driving circuit (23) should increase driving currents for those particular red LEDs (12) to increase their brightness.

In conclusion, together with the timing control to select a group of LEDs of a particular color at a time, the present invention uses the photo sensors to sense and acquire the brightness values of the LEDs to adjust the brightness of the LEDs. Such photo sensors are relatively cheap and result in a lower cost.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A brightness adjusting method for an LED-based display panel having light emitting diodes (LEDs) divided into groups according to color, the method comprising
sequentially turning on one of the groups of the LEDs;
sensing brightness of the groups of the LEDs with at least one photo sensor and generating brightness values corresponding to different colors;
storing the brightness values;
comparing the brightness values to default standard brightness values; and
adjusting brightness of the LEDs based on the compared results.

2. The brightness adjusting method as claimed in claim 1, wherein multiple sensors are used to sense the LEDs and generate multiple sets of brightness values, and each set of brightness values corresponds to one color.

3. The brightness adjusting method as claimed in claim 2, wherein LEDs corresponding to the one of the brightness values are adjusted to enhance their brightness when one of the brightness values is lower than a corresponding standard brightness value.

4. The brightness adjusting method as claimed in claim 3, wherein the multiple photo sensors are mounted on the LED-based display panel above the LEDs.

5. The brightness adjusting method as claimed in claim 4, wherein the multiple groups of the LEDs comprise groups of red LEDs, green LEDs and blue LEDs.

6. A brightness adjusting device for an LED-based display panel having light emitting diodes (LEDs) divided into groups according to color, the brightness adjusting device comprising
at least one photo sensor being mounted on the LED-based display panel and sensing brightness of the LEDs to generate brightness values corresponding to the multiple groups of the LEDs;
a control circuit being connected to the at least one photo sensor, receiving the brightness values and comparing the brightness values to default standard brightness values;
a timing controller being connected to the control circuit and outputting a timing signal; and
a driving circuit being connected to the LED-based display and the timing controller, controlling the LED-based panel according to the timing signal so that the multiple groups of the LEDs are sequentially turned on, and adjusting brightness of the LEDs based on compared results of the control circuit.

7. The brightness adjusting device as claimed in claim 5, wherein multiple photo sensors are mounted on the LED-based display panel to sense the LEDs and generate multiple sets of the brightness values, and each set of the brightness values corresponds to one color.

8. The brightness adjusting device as claimed in claim 6, wherein when one of the brightness values is lower than a corresponding standard brightness value, the LEDs corresponding to the one of the brightness values are adjusted to enhance their brightness.
